(19) United States
(12) Patent Application Publication
(10) Pub. No.: US 2007/0029043 A1
(43) Pub. Date: Feb. 8, 2007

(54) Pre-made cleavable substrate method and structure of fabricating devices using one or more films provided by a layer transfer process

(75) Inventor: Francois J. Henley, Aptos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Silicon Genesis Corporation, San Jose, CA (US)

(21) Appl. No.: 11/200,413

(22) Filed: Aug. 8, 2005

(51) Int. Cl. B29C 63/00

(52) U.S. Cl. 156/344

(57) ABSTRACT

A method for fabricating one or more devices, e.g., integrated circuits. The method includes providing a multi-layered substrate, which has a thickness of material (e.g., single crystal silicon) overlying a first debondable surface coupled to and overlying a second debondable surface. The second debondable surface is overlying an interface region of the multi-layered substrate. In a preferred embodiment, the thickness of material having a surface region. The method includes processing the surface region of the multi-layered substrate using one or more processes to form at least one device onto a portion of the surface region. The method includes forming a planarized upper surface region overlying the surface region of the thickness of material. The method includes joining the planarized upper surface region to a face of a handle substrate. In a preferred embodiment, the method includes processing the first debondable surface and the second debondable surface to change a bond strength from a first determined amount to a second determined amount, which is capable of debonding the first debondable surface from the second debondable surface. The method includes debonding the first debondable surface from the second debondable surface to release the thickness of material and the handle substrate.

### BACKGROUND OF THE INVENTION

The present invention relates to the manufacture of substrates. More particularly, the invention provides a technique including a method and a structure for forming multi-layered substrate structures for the fabrication of substrates for semiconductor integrated circuit devices using layer transfer techniques. But it will be recognized that the invention has a wider range of applicability; it can also be applied to other types of substrates for three-dimensional packaging of integrated semiconductor devices, photonic devices, piezoelectronic devices, flat panel displays, microelectromechanical systems (“MEMS”), nano-technology structures, sensors, actuators, solar cells, biological and biomedical devices, and the like.

From the very early days, human beings have been building useful articles, tools, or devices using less useful materials for numerous years. In some cases, articles are assembled by way of smaller elements or building blocks. Alternatively, less useful articles are separated into smaller pieces to improve their utility. A common example of these articles to be separated include substrate structures, such as a glass plate, a diamond, a semiconductor substrate, a flat panel display, and others. These substrate structures are often cleaved or separated using a variety of techniques. In some cases, the substrates can be separated using a saw operation. The saw operation generally relies upon a rotating blade or tool, which cuts through the substrate material to separate the substrate material into two pieces. This technique, however, is often extremely “rough” and cannot generally be used for providing precision separations in the substrate for the manufacture of fine tools and assemblies. Additionally, the saw operation often has difficulty separating or cutting extremely hard and or brittle materials, such as diamond or glass. The saw operation also cannot be used effectively for the manufacture of microelectronic devices, including integrated circuit devices, and the like.

Accordingly, techniques have been developed to fabricate microelectronic devices, commonly called semiconductor integrated circuits. Such integrated circuits are often developed using a technique called the “planar process” developed in the early days of semiconductor manufacturing. An example of one of the early semiconductor techniques is described in U.S. Pat. No. 2,981,877, in the name of Robert Noyce, who has been recognized as one of the father's of the integrated circuit. Such integrated circuits have evolved from a handful of electronic elements into millions and even billions of components fabricated on a small slice of silicon material. Such integrated circuits have been incorporated into and control many of today's devices, such as computers, cellular phones, toys, automobiles, and all types of medical equipment.

Conventional integrated circuits provide performance and complexity far beyond what was originally imagined. In order to achieve improvements in complexity and circuit density (i.e., the number of devices capable of being packed onto a given chip area), the size of the smallest device feature, also known as the device “geometry”, has become smaller with each generation of integrated circuits. Increasing circuit density has not only improved the complexity and performance of integrated circuits but has also provided lower cost parts to the consumer.

Making devices smaller is very challenging, as each process used in integrated fabrication has a limit. That is to say, a given process typically only works down to a certain feature size, and then either the process or the device layout needs to be changed. Additionally, as devices require faster and faster designs, process limitations exist with certain conventional processes and materials. An example of such a process is an ability to make the thickness of the substrate thin after the manufacture of the integrated circuit devices thereon. A conventional process often used to thin these device layers is often called “back grinding,” which is often cumbersome, prone to cause device failures, and can only thin the device layer to a certain thickness. Although there have been significant improvements, such back grinding processes still have many limitations.

Accordingly, certain techniques have been developed to cleave a thin film of crystalline material from a larger donor substrate portion. These techniques are commonly known as “layer transfer” processes. Such layer transfer processes have been useful in the manufacture of specialized substrate structures, such as silicon on insulator or display substrates. As merely an example, a pioneering technique was developed by Francois J. Henley and Nathan Chung to cleave films of materials. Such technique has been described in U.S. Pat. No. 6,013,563 titled Controlled Cleaving Process, assigned to Silicon Genesis Corporation of San Jose, Calif., and hereby incorporated by reference for all purposes. Although such technique has been successful, there is still a desire for improved ways of manufacturing multilayered structures.

From the above, it is seen that a technique for manufacturing large substrates which is cost effective and efficient is desirable.

### BRIEF SUMMARY OF THE INVENTION

According to the present invention, techniques related to the manufacture of substrates are provided. More particularly, the invention provides a technique including a method and a structure for forming multi-layered substrate structures for the fabrication of substrates for semiconductor integrated circuit devices using layer transfer techniques. But it will be recognized that the invention has a wider range of applicability; it can also be applied to other types of substrates for three-dimensional packaging of integrated semiconductor devices, photonic devices, piezoelectronic devices, flat panel displays, microelectromechanical systems (“MEMS”), nano-technology structures, sensors, actuators, solar cells, biological and biomedical devices, and the like.

In a specific embodiment, the present invention provides a method for fabricating one or more devices, e.g., integrated circuits. The method includes providing a multi-layered substrate, which has a thickness of material (e.g., single crystal silicon) overlying a first debondable surface coupled to and overlying a second debondable surface. The first and second debondable surfaces define a debondable interface region of the multi-layered substrate in a specific embodiment. In a preferred embodiment, the thickness of material has a surface region. The method includes processing the surface region of the multi-layered substrate using one or more processes to form at least one device onto a portion of the surface region. In a preferred embodiment, the processing includes at least a thermal process of about 1000 degrees centigrade and greater. The method includes forming a planarized upper surface region overlying the surface region of the thickness of material. The method includes joining the planarized upper surface region to a face of a handle substrate. In a preferred embodiment, the method includes processing the first debondable surface and the second debondable surface to change a bond strength from a first determined amount (e.g., bonding regime) to a second determined amount, which is capable of debonding the first debondable surface from the second debondable surface. In a preferred embodiment, the second determined amount is in an “adherence” region, which is between a non-bonding regime and bonding regime according to a specific embodiment. The method includes debonding the first debondable surface from the second debondable surface to release the thickness of material and the handle substrate.

Depending upon the embodiment, the invention provides a variety of ways to process the first and second debondable surfaces to change a bond strength from a first determined amount (e.g., bonding regime) to a second determined amount, which is capable of debonding the first debondable surface from the second debondable surface. Such surfaces can be processed through a portion or an entirety of the processing techniques and/or processed independently from any of the recited steps according to a specific embodiment. In a specific embodiment, the processing of the first debondable surface and the second debondable surface causes a change in volume of a region within a vicinity of an interface between the first debondable surface and the second debondable surface to change the bond strength to the second determined amount. In an alternative embodiment, the processing of the first debondable surface and the second debondable surface causes a chemical reaction within a vicinity of an interface between the first debondable surface and the second debondable surface to change the bond strength to the second determined amount. In an alternative embodiment, the processing of the first debondable surface and the second debondable surface comprises a thermal process to causes an increased surface roughness within a vicinity of an interface between the first debondable surface and the second debondable surface to change the bond strength to the second determined amount. Depending upon the embodiment, one or more of these processes may be used. Of course, there can be other variations, modifications, and alternatives.

In an specific embodiment, the present method and structure provides an interface between the two debondable surfaces that can be formed with certain desired characteristics. In a specific embodiment, the interface, which debonds, is debonded using a cleaving technique. The interface can be formed to be “cleavable” upon an unchanged or increasing bond strength between the substrates according to a specific embodiment. That is, the bond strength between the first debondable surface and the second debondable surface is unchanged or increasing according to a specific embodiment. The debondable interface can also be debonded via cleaving (a) after the first debondable substrate is bonded to the second debondable substrate (which may be possible because a cleave energy associated with the interface is made low enough) and/or (b) after integrated circuit processing and bonding of the multilayered substrate to the final handle substrate. Here, the term “cleave” is to be defined according to an ordinary meaning, which may be apart from it's meaning as associated with a layer transfer technique according to a specific embodiment. In a preferred embodiment, the cleaving can be performed using a cleaving tool, such as those described in PCT/US05/007747 filed Jan. 10, 2005 (Attorney Docket No. 181419-017100PC), commonly assigned and hereby incorporated by reference for all purposes. Of course, there can be other variations, modification, and alternatives.

In an alternative specific embodiment, the present invention provides a method for fabricating one or more devices, e.g., integrated circuit, optical, MEMS. The method includes providing a multi-layered substrate. In a preferred embodiment, the multi-layered substrate has a thickness of material (e.g., single crystal silicon) overlying a first debondable surface coupled to and overlying a second debondable surface. The first and second debondable surfaces define a debondable interface region of the multi-layered substrate, which also has a surface region. The method includes processing the surface region of the multi-layered substrate using one or more processes to form at least one device onto a portion of the surface region. The method also includes forming a planarized upper surface region overlying the surface region of the thickness of material. The method includes joining the planarized upper surface region to a face of a handle substrate. In a preferred embodiment, the method includes processing the first debondable surface and the second debondable surface using a thermal process to change a bond strength from a first determined amount to a second determined amount, which is capable of debonding the first debondable surface from the second debondable surface. The thermal process causes a change in one or more characteristics within a vicinity of an interface between the first debondable surface and the second debondable surface to change the bond strength from the first determined amount to the second determined amount. The first determined amount corresponds to a bonding strength within a bonding regime according to a specific embodiment. In a preferred embodiment, the second determined amount corresponds to a bonding strength within an adherence region. The method includes debonding the first debondable surface from the second debondable surface to release the thickness of material and the handle substrate.

Other ways of changing the bond strength can include an activation process that introduces a certain external energy within a vicinity of the interface region. The activation process may be pulsed and/or continuous according to a specific embodiment. The process can include an electromagnetic process (e.g., heating by induction or a laser process), a rapid thermal treatment process, a mechanical process (e.g., pulse), a chemical process (e.g., bond and cleave within a predetermined time or the bond strength begin strengthening again to the first predetermined amount), or any combination of these. Of course, there can be other variations, modifications, and alternatives.

In yet an alternative specific embodiment, the present invention provides a method for fabricating one or more devices. The method includes providing a donor substrate having a thickness of material overlying a cleave region. The donor substrate has a first debondable surface overlying the thickness of material. The method includes joining the first debondable surface with a second debondable surface of a first handle substrate. In a preferred embodiment, the method includes cleaving the cleave region to transfer the thickness of material from the donor substrate to the handle substrate while the first debondable surface remains attached to the second debondable surface to form a multi-layered substrate, which now has the thickness of material overlying the first debondable surface coupled to and overlying the second debondable surface. The first debondable surface and the second debondable surface defines an interface region between (and/or within a region within the interface) them in the multi-layered substrate. The method includes processing the surface region of the multi-layered substrate using one or more processes to form at least one device onto a portion of the surface region. The method includes forming a planarized upper surface region overlying the surface region of the thickness of material and joining the planarized upper surface region to a face of a handle substrate. The method includes processing the first debondable surface and the second debondable surface to change a bond strength from a first determined amount to a second determined amount, which is capable of debonding the first debondable surface from the second debondable surface. The method includes debonding the first debondable surface from the second debondable surface to release the thickness of material and the handle substrate.

Depending upon the specific embodiment, the first debondable surface joined to the second debondable surface is characterized by a bond strength greater than a strength of the cleave region after the first debondable surface has been joined to the second debondable surface. Alternatively, the second determined bond strength is less than a bond strength associated with the planarized upper surface region and the face of the handle substrate and the second determined bond strength being characterized as cleavable after the planarized upper surface region and the face of the handle substrate have been joined. Of course, there can be various modifications, alternatives, and variations. The invention can also provide a multi-layered substrate structure capable of being debondable according to a specific embodiment.

Numerous benefits are achieved over pre-existing techniques using the present invention. In particular, the present invention uses controlled energy and selected conditions to preferentially cleave a thin film of material without a possibility of damage to such film from excessive energy release. This cleaving process selectively removes the thin film of material from the substrate while preventing a possibility of damage to the film or a remaining portion of the substrate. Additionally, the present method and structures allow for more efficient processing using a cleave layer provided in a substrate through the course of semiconductor processing, which may occur at higher temperatures, according to a specific embodiment Once the cleaved layer has been subjected to integrated circuit processing techniques, a handle substrate, which held the cleaved layer is debondable. In a preferred embodiment, the present invention provides a multi-layered substrate that can withstand semiconductor processing but still allow for a thin layer to be debondable in an efficient manner without damaging the thin layer including any of the devices thereon. Depending upon the embodiment, one or more of these benefits may be achieved. These and other benefits may be described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 illustrates an overall simplified method for manufacturing integrated circuits on a layer transferred substrate using a thin handle substrate according to embodiments of the present invention; and

FIGS. 2 through 10 illustrate a simplified method for manufacturing integrated circuits on a layer transferred substrate using a thin handle substrate according to embodiments of the present invention.

### DETAILED DESCRIPTION OF THE INVENTION

According to the present invention, techniques related to the manufacture of substrates are provided. More particularly, the invention provides a technique including a method and a structure for forming multi-layered substrate structures for the fabrication of substrates for semiconductor integrated circuit devices using layer transfer techniques. But it will be recognized that the invention has a wider range of applicability; it can also be applied to other types of substrates for three-dimensional packaging (e.g., wafer scale) of integrated semiconductor devices, photonic devices, piezoelectronic devices, flat panel displays, microelectromechanical systems (“MEMS”), nano-technology structures, sensors, actuators, solar cells, biological and biomedical devices, and the like.

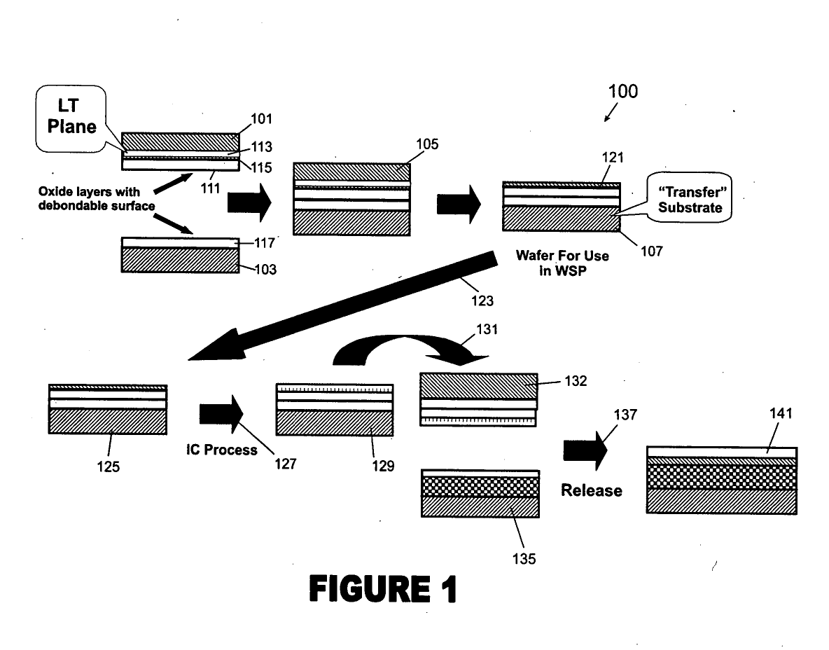

Referring to FIG. 1, a method 100 for fabricating integrated circuits on a layer transferred substrate according to embodiments of the present invention may be outlined as follows:

1 Provide a semiconductor substrate 101, e.g., silicon, germanium, a silicon-germanium alloy, gallium arsenide, any Group III/V materials, and others;

2. Form a cleave plane 113 (including a plurality of particles, deposited material, or any combination of these, and the like) to define a thickness of semiconductor material 115 (which is from a donor substrate) provided within the semiconductor substrate;

3. Form a first debondable surface 111 overlying a surface of the semiconductor substrate;

4. Provide a transfer substrate member 103 (e.g., glass, silicon, quartz, plastic) including a second debondable 117;

5. Join the first debondable surface of the semiconductor substrate with the second debondable surface of the transfer substrate member to form a first multi-layered structure 105, which has the thickness of material (e.g., single crystal silicon) overlying the first debondable surface coupled to and overlying the second debondable surface (as merely an example, for silicon substrates, each of the substrates may include an overlying layer of oxide, which facilitates bonding of the substrates);

6. Cleave a portion of the semiconductor substrate via the cleave plane to transfer the thickness of material 121 from the semiconductor substrate to the transfer substrate member to form a multi-layered transfer substrate 107, while the first debondable surface remains attached to the second debondable surface (the first debondable surface and second debondable surface have a bond strength greater than a strength of the cleave plane and/or region of the transfer substrate);

7. Optionally, process the surface region of the multi-layered transfer substrate 125 using one or more processes;

8. Process 127 the multi-layered substrate including the surface region to form at least one device 129 (e.g., integrated circuit, optical, LCD device, MEMS) onto a portion of the surface region (where the device and substrate includes one or more interconnect layers);

9. Form a planarized upper surface region (e.g., planarized oxide, passivation layer, polished dielectric surface, which is bondable) overlying the surface region of the thickness of material;

10. Align 131 the planarized surface region overlying the thickness of material with a handle substrate 135 (e.g., polymer, plastic), which may be a “finalized” handle substrate (which may have been subjected to integrated circuit processing or multiple integrated circuit processing steps from an initial process to a final process to complete a finalized integrated circuit device);

11. Join 132 the planarized upper surface region to a face of the handle substrate;

12. Process (which may occur in any or all of the steps above, and/or as well as others) the first debondable surface and the second debondable surface to change a bond strength from a first determined amount (e.g., bonding regime) to a second determined amount, which is capable of debonding the first debondable surface from the second debondable surface;

13. Debond 137 the first debondable surface from the second debondable surface to release the thickness of material and the handle substrate to form a resulting substrate structure 141 using a controlled cleaving process, while the planarized surface region and the face of the handle substrate, which are characterized by a greater strength, remain attached to each other;

14. Optionally, the above steps can be repeated again for at least one or more other layers, which includes other integrated circuit device elements or other features; and

15. Perform other steps, as desired.

The above sequence of steps provides a method according to an embodiment of the present invention. As shown, the method uses a combination of steps including a way of forming a transfer substrate, including a debondable interface region, which becomes debondable based upon certain process steps that may occur through processing of the transfer substrate according to a specific embodiment. Depending upon the embodiment, the debondable interface region changes from a first strength to a second strength, which may be the same or different (e.g., increasing, decreasing). Other alternatives can also be provided where steps are added, one or more steps are removed, or one or more steps are provided in a different sequence without departing from the scope of the claims herein. Further details of the present method can be found throughout the present specification and more particularly below.

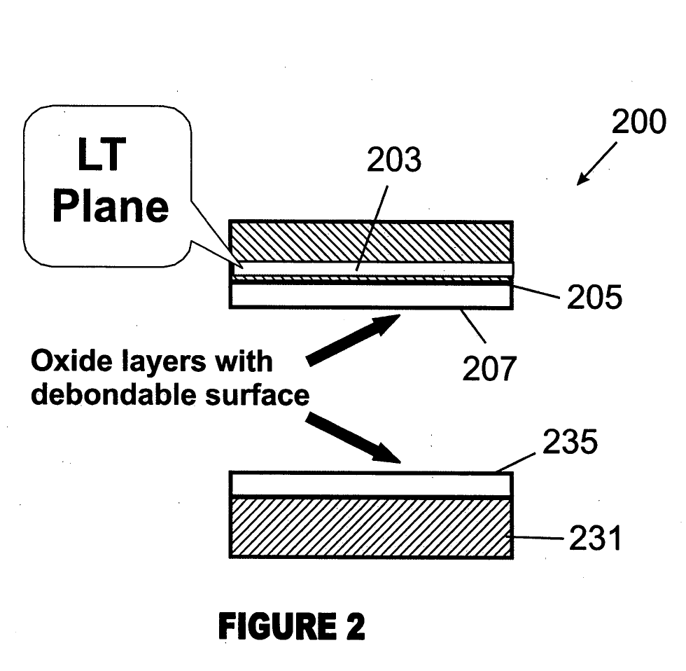

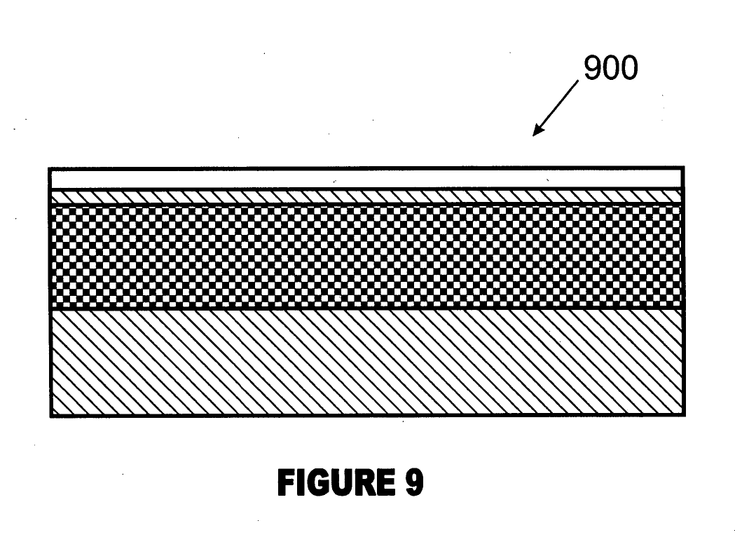

FIGS. 2 through 10 illustrate a simplified method for manufacturing integrated circuits on a layer transferred substrate according to embodiments of the present invention. These diagrams are merely illustrations that should not unduly limit the scope of the claims herein. One of ordinary skill in the art would recognize other variations, modifications, and alternatives. As shown, the method includes providing a semiconductor substrate 200, e.g., silicon, germanium, a silicon carbide, a silicon-germanium alloy, gallium arsenide, any Group III/V or II/VI materials, and others. In a specific embodiment, the semiconductor substrate can be made of a single homogenous material, or a combination of various layers, depending upon the specific embodiment. Of course, there can be other variations, modifications, and alternatives.

In a preferred embodiment, the substrate has a thickness of semiconductor material 205 and a surface region, which is a first debondable surface 207. In a specific embodiment, the substrate also has a cleave plane 203 (including a plurality of particles, deposited material, or any combination of these, and the like) provided within the substrate, which defines the thickness of semiconductor material. Of course, there can be other variations, modifications, and alternatives.

Depending upon the embodiment, the cleave region can be formed using a variety of techniques. That is, the cleave region can be formed using any suitable combination of implanted particles, deposited layers, diffused materials, patterned regions, and other techniques. In a specific embodiment, the method introduces certain energetic particles using an implant process through a top surface of the semiconductor substrate, which can be termed a donor substrate, to a selected depth, which defines the thickness of the semiconductor material region, termed the “thin film” of material. A variety of techniques can be used to implant the energetic particles into a single crystal silicon wafer according to a specific embodiment. These techniques include ion implantation using, for example, beam line ion implantation equipment manufactured from companies such as Applied Materials, Inc. and others. Alternatively, implantation occurs using a plasma immersion ion implantation (“PIII”) technique, ion shower, and other non-mass specific techniques can be particularly effective for larger surface regions according to a specific embodiment. Combination of such techniques may also be used Of course, techniques used depend upon the application.

Depending upon the application, smaller mass particles are generally selected to reduce a possibility of damage to the material region according to a preferred embodiment. That is, smaller mass particles easily travel through the substrate material to the selected depth without substantially damaging the material region that the particles traverse through. For example, the smaller mass particles (or energetic particles) can be almost any charged (e.g., positive or negative) and or neutral atoms or molecules, or electrons, or the like. In a specific embodiment, the particles can be neutral and or charged particles including ions such as ions of hydrogen and its isotopes, rare gas ions such as helium and its isotopes, and neon, or others depending upon the embodiment. The particles can also be derived from compounds such as gases, e.g., hydrogen gas, water vapor, methane, and hydrogen compounds, and other light atomic mass particles. Alternatively, the particles can be any combination of the above particles, and or ions and or molecular species and or atomic species. The particles generally have sufficient kinetic energy to penetrate through the surface to the selected depth underneath the surface.

Using hydrogen as the implanted species into the silicon wafer as an example, the implantation process is performed using a specific set of conditions. Implantation dose ranges from about 10¹⁵ to about 10¹⁸ atoms/cm², and preferably the dose is greater than about 10¹⁶ atoms/cm². Implantation energy ranges from about 1 KeV to about 1 MeV, and is generally about 50 KeV. Implantation temperature ranges from about −20 to about 600 Degrees Celsius, and is preferably less than about 400 Degrees Celsius to prevent a possibility of a substantial quantity of hydrogen ions from diffusing out of the implanted silicon wafer and annealing the implanted damage and stress The hydrogen ions can be selectively introduced into the silicon wafer to the selected depth at an accuracy of about ±0.03 to ±0.05 microns. Of course, the type of ion used and process conditions depend upon the application.

Effectively, the implanted particles add stress or reduce fracture energy along a plane parallel to the top surface of the substrate at the selected depth. The energies depend, in part, upon the implantation species and conditions. These particles reduce a fracture energy level of the substrate at the selected depth. This allows for a controlled cleave along the implanted plane at the selected depth. Implantation can occur under conditions such that the energy state of the substrate at all internal locations is insufficient to initiate a non-reversible fracture (i.e., separation or cleaving) in the substrate material. It should be noted, however, that implantation does generally cause a certain amount of defects (e.g., micro-detects) in the substrate that can typically at least partially be repaired by subsequent heat treatment, e.g., thermal annealing or rapid thermal annealing. Of course, there can be other variations, modifications, and alternatives.

Depending upon the embodiment, there may be other techniques for forming a cleave region and/or cleave layer. As merely an example, such cleave region is formed using other processes, such as those using a silicon-germanium cleave plane developed by Silicon Genesis Corporation of Santa Clara, Calif. and processes such as the SmartCut™ process of Soitec SA of France, and the Eltran™ process of Canon Inc. of Tokyo, Japan, any like processes, and others. Of course, there may be other variations, modifications, and alternatives.

As shown, the present method forms the first debondable surface overlying a surface of the semiconductor substrate. The method also provides a transfer substrate member including a second debondable according to a specific embodiment. In a specific embodiment, the transfer substrate member can be made of a suitable material including a semiconductor (e.g., silicon, germanium, silicon, germanium, a silicon carbide, a silicon-germanium alloy, gallium arsenide, any Group III/V or II/IV materials, and others), an insulating material (e.g., glass, quartz, sapphire, ceramic, polymer), and/or a metal material (e.g., aluminum) and/or other combinations of these, and the like. The transfer substrate can also be homogeneous and/or made of multiple materials according to a specific embodiment. In a specific embodiment, the selection of the appropriate material depends on an expected thermal profile and an ability of the respective materials to with stand thermal stressed caused by differences in respective thermal expansion coefficients and the materials' ability to withstand one or more processing temperature ranges. For example, for processing of integrated circuits, a preferred transfer substrate may be a silicon substrate including some layers such as silicon dioxide and/or other suitable continuous and/or patterned layers of adjusted roughness to form the debondable surface(s). Adjustment of the bonding processes and selection of the surface materials are also provided for the appropriate debondable surface energy characteristics according to a specific embodiment. Of course, there can be other variations, modifications, and alternatives.

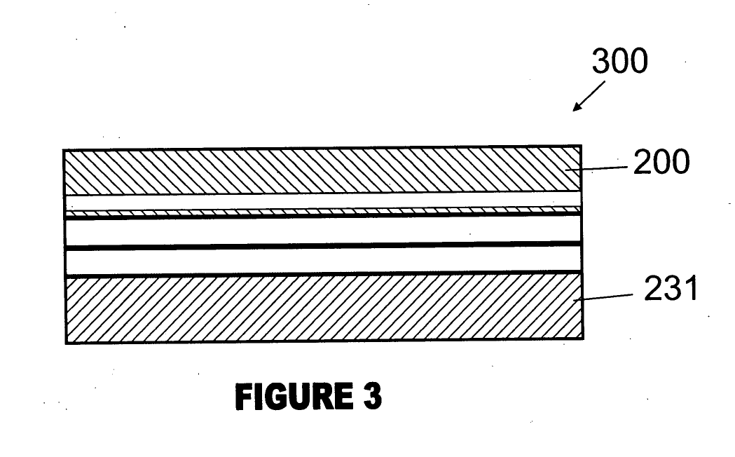

Referring to FIG. 3, the method joins the first debondable surface of the semiconductor substrate with the second debondable surface of the transfer substrate member to form a first multi-layered structure. In a specific embodiment, the first multi-layered structure has the thickness of material (e.g., single crystal silicon) overlying the first debondable surface coupled to and overlying the second debondable surface. The first debondable surface is maintained overlying the cleave layer, which is provided on the semiconductor substrate, as shown.

In a specific embodiment, the first debondable surface and second debondable surface have certain desired characteristics. In a preferred embodiment, such surfaces are bonded to each other and maintained during a cleaving process and also maintained in the bonded state during the manufacture of devices, such as integrated circuit devices. As device processing continues and/or at a certain process event or events, the first bondable surface and the second bondable surface become debondable according to a specific embodiment. That is, the bonded surfaces are characterized as having a strength in an adherence regime, rather than a bonding regime, according to a specific embodiment. Further details of the present bonding and debonding techniques can be found throughout the present specification and more particularly below. As merely an example, “The Effect of Surface Roughness on Direct Wafer Bonding,” C. Gui, M. Elwenspoek, N. Tas, and J. G. E. Gardeniers, Mesa Research Institute, University of Twente, The Netherlands, Journal of Applied Physics, Volume 85, Number 10 (May 15, 1999) and “Selective Wafer Bonding by Surface Roughness Control, ” C. Gui, R. E. Oosterbroek, J. W. Berenschot, S. Schlautmann, T. S. J. Lammerink, A. Van Der Berg, and M. C. Elwenspoek, Mesa Research Institute, University of Twente, The Netherlands, Journal of The Electrochemical Society, 148 (4) G225-G228 (2001) illustrates certain bonding techniques, and are hereby incorporated by reference for all purposes.

Before joining, the debondable surfaces are each subjected to a cleaning solution to treat the surfaces of the substrates to clean the substrate surface regions according to a specific embodiment. An example of a solution used to clean the substrate and transfer member surfaces is a mixture of hydrogen peroxide and sulfuric acid, and other like solutions. A dryer dries the substrate and transfer member surfaces to remove any residual liquids and/or particles from the substrate surfaces. Self-bonding occurs by placing surfaces of cleaned substrates (e.g., semiconductor substrate surface and transfer substrate surface) together after an optional plasma activation process depending on the specific layer-transfer process used. If desired, such plasma activated processes clean and/or activate the surfaces of the substrates. The plasma activated processes are provided, for example, using an oxygen or nitrogen bearing plasma at 20° C. to 40° C. temperature. The plasma activated processes are preferably carried out in dual frequency plasma activation system manufactured by Silicon Genesis Corporation of San Jose, Calif. Of course, there can be other variations, modifications, and alternatives, which have been described herein, as well as outside of the present specification.

Thereafter, each of these substrates is bonded together according to a specific embodiment. The substrates are preferably bonded using an EVG 850 bonding tool manufactured by Electronic Vision Group or other like processes for smaller substrate sizes such as 200 mm or 300 mm diameter wafers. Other types of tools such as those manufactured by Karl Suss may also be used. Of course, there can be other variations, modifications, and alternatives. Preferably, bonding between the substrates is substantially permanent and has good reliability through an entirety of the semiconductor processing steps, but is releasable upon completion of the semiconductor process steps according to the preferred embodiment.

Accordingly after bonding, the bonded substrate structures are subjected to a bake treatment according to a specific embodiment. The bake treatment maintains the bonded substrate at a predetermined temperature and predetermined time. Preferably, the temperature ranges from about 200 or 250 Degrees Celsius to about 400 Degrees Celsius and is preferably about 350 Degrees Celsius for about 1 hour or so for a silicon donor substrate, for example, and the transfer substrate member to attach themselves to each other at least during one or more semiconductor manufacturing processes according to the preferred embodiment. Depending upon the specific application, there can be other variations, modifications, and alternatives.

In a specific embodiment, the substrates are joined or fused together using a low temperature thermal step. In a specific embodiment, the low temperature bonding process occurs by a self-bonding process. Alternatively, an adhesive disposed on either or both surfaces of the substrates, which bond one substrate to another substrate. In a specific embodiment, the adhesive includes an epoxy, polyimide-type materials, and the like. Spin-on-glass layers can be used to bond one substrate surface onto the face of another. These spin-on-glass (“SOG”) materials include, among others, siloxanes or silicates, which are often mixed with alcohol-based solvents or the like. SOG can be a desirable material because of the low temperatures (e.g., 150 to 250 degree C.) often needed to cure the SOG after it is applied to surfaces of the wafers.

Alternatively, a variety of other low temperature techniques can be used to join the donor substrate surface regions to the transfer substrate according to a specific embodiment. For instance, an electro-static bonding technique can be used to join the two substrates together. In particular, one or both substrate surface(s) is charged to attract to the other substrate surface. Additionally, the donor substrate surface can be fused to the handle wafer using a variety of other commonly known techniques. Of course, the technique used depends upon the application.

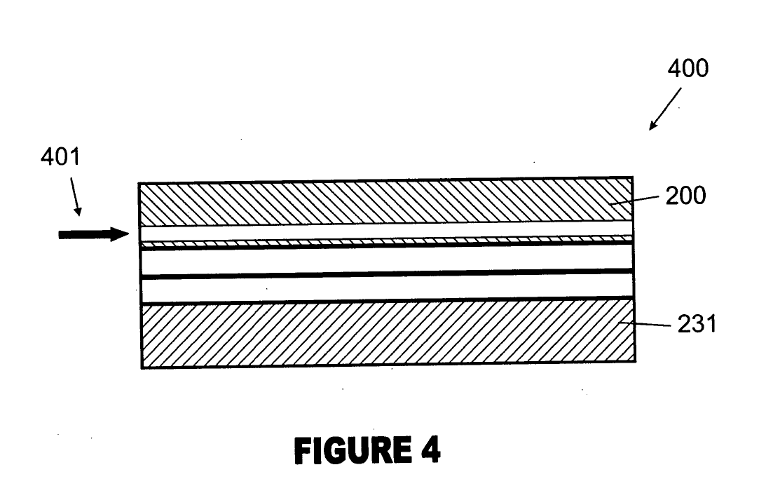

Referring to FIG. 4, the method includes initiating a controlled cleaving action using energy 401 provided at a selected portion of the cleave plane to detach the thickness of semiconductor material from the substrates according to a specific embodiment. Depending upon the specific embodiment, there can be certain variations. For example, the cleaving process can be a controlled cleaving process using a propagating cleave front to selectively free the thickness of material from the donor substrate attached to the transfer substrate. Alternative techniques for cleaving can also be used. Such techniques, include, but are not limited to those called a Nanocleave™ process of Silicon Genesis Corporation of Santa Clara, Calif., a SmartCut™ process of Soitec SA of France, and an Eltran™ process of Canon Inc. of Tokyo, Japan, any like processes, and others. The method then removes the remaining portion of the thickness of material from the semiconductor substrate and transfers the thickness of material to the transfer substrate member according to a specific embodiment.

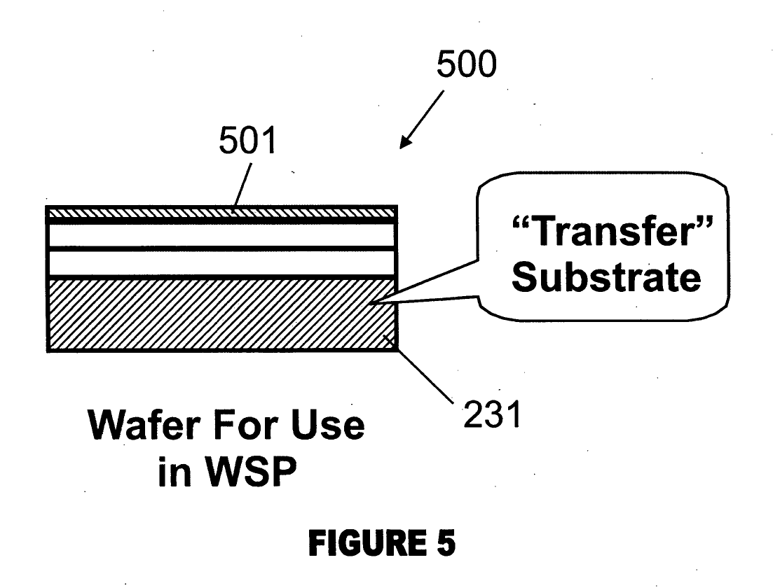

Referring to FIG. 5, the method provides a resulting transfer substrate 600 including bonded first and second debondable surfaces and overlying thickness of semiconductor material 501, each of which is coupled to a transfer substrate member according to a specific embodiment. In a preferred embodiment, the total thicknesses including the transfer substrate member and thickness of material are characterized by a total thickness ranging at about 825 microns and a diameter of about 200 millimeters. Such total thickness allows for processing of the substrate using conventional semiconductor processing tools, and the like for device fabrication according to a specific embodiment. Of course, there can be other modifications, variations, and alternatives.

In a specific embodiment, the resulting transfer substrate including thickness of material may be subjected to surface treatment processes before fabrication of integrated circuits thereon. As merely an example, the surface treatment can include a smoothing process, which can be a thermal treatment and chemical etching process, chemical mechanical polishing process, or any combination of these, depending upon the specific embodiment. As merely an example, a surface smoothing process may be illustrated by U.S. Pat. No. 6,287,941 in the names of Kang, et al., which issued on Sep. 11, 2001, commonly assigned, and hereby incorporated by reference for all purposes. In an alternative embodiment, the thickness of material may be formed using a silicon germanium cleave plane, such as those mentioned in U.S. Pat. No. 6,033,974, in the names of Henley, et al., which issued on Mar. 7, 2000, commonly assigned, and hereby incorporated by reference for all purposes. The “as cleaved” surface may be suitable for device processing according to a specific embodiment. Of course one of ordinary skill in the art would recognize many variations, alternatives, and modifications.

In a specific embodiment, the resulting transfer substrate and thickness of material have suitable characteristics for undergoing one or more processing steps. That is, the transfer substrate can be subjected to conventional semiconductor processing techniques, including but not limited to, photolithography, etching, implanting, thermal annealing, chemical mechanical polishing, diffusion, deposition, and other others, which may be known by one of ordinary skill in the art. The second handle substrate can also be selectively removed while transferring the thin film of material onto another substrate structure according to a specific embodiment. In a specific embodiment, it is believed that a bond energy exceeding approximately 100 milli-Joule/m² is required to allow the processing steps to occur without bond failure according to a specific embodiment. A bond failure can be defined as a partial or complete uncontrolled debonding of the debondable surface before the desired debonding step 137 according to a specific embodiment.

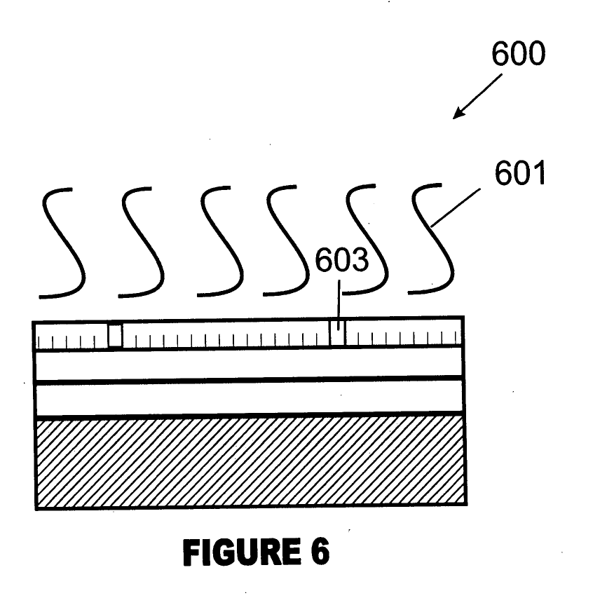

Referring to FIG. 6, the present method performs processes 601 on portions of the thickness of semiconductor material, which has been attached to the transfer substrate. The method forms one or more devices 603 on one or more portions of the thin film of material overlying the substrate surface. Such devices can include integrated semiconductor devices, photonic and/or optoelectronic devices (e.g., light valves), piezoelectronic devices, microelectromechanical systems (“MEMS”), nano-technology structures, sensors, actuators, solar cells, flat panel display devices (e.g., LCD, AMLCD), biological and biomedical devices, and the like. Such devices can be made using deposition, etching, implantation, photo masking processes, any combination of these, and the like. Of course, there can be other variations, modifications, and alternatives. Additionally, other steps can also be formed, as desired.

In a preferred embodiment, the processing includes one or more high temperature semiconductor processing techniques to form conventional integrated circuits thereon. The method forms a planarized surface region 703 overlying the thickness of semiconductor material. In a specific embodiment, the planarized surface region can be formed using one or more suitable techniques. Such techniques include deposition of a dielectric layer, which is later reflowed using thermal treatment. The planarized surface region can also be formed using a chemical mechanical polishing process including a suitable slurry, pad, and process according to a specific embodiment. The planarized surface region can also be formed using any combination of these techniques and others according to a specific embodiment. The planarized surface region preferably has a uniformity of about 0.1% to about 5% end to end, and is within about 15 Angstroms RMS in roughness as measured on a 2 micron by 2 micron atomic-force microscope scan according to a specific embodiment. Of course, there can be other variations, modifications, and alternatives.

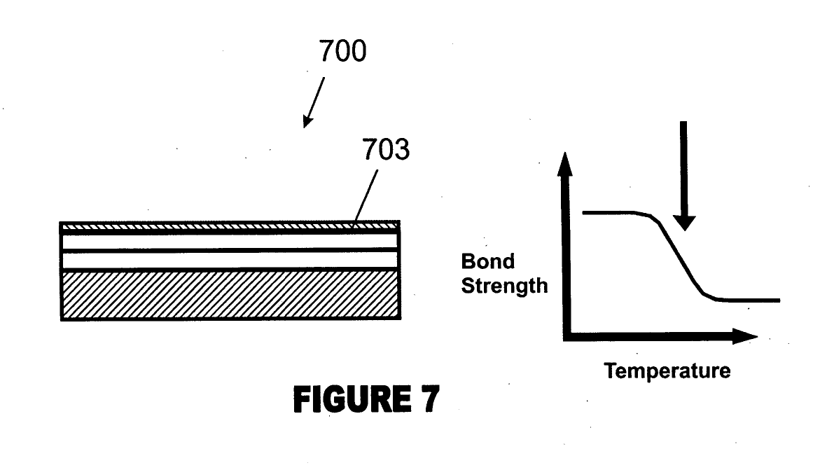

Referring again to FIG. 7, the two debondable surfaces, which have been bonded together, change in characteristic as they undergo certain processing conditions. As illustrated in the plot, which has bonding strength along the vertical axis, which intersects temperature along the horizontal axis, bonding strength decreases with an increasing temperature budget according to a specific embodiment. Initially, the two debondable surfaces are firmly engaged and bonded to each other and not capable of being separated using conventional techniques. As the substrate including the two surfaces is subjected to one or more thermal processes, the bonding strength changes from a bonding regime to an adherence regime, which allows for debonding the first surface from the second surface according to a specific embodiment. Alternatively, the two surfaces may be bonded at a strength in the adherence region initially, which continues through device processing according to a specific embodiment. In a preferred embodiment, the two surfaces are substantially together and do not delaminate and/or cause other imperfections and/or undesirable results during processing of an integrated circuit, but before debonding of the surfaces according to a specific embodiment. Further details of the debonding technique can be found throughout the present specification and more particularly below.

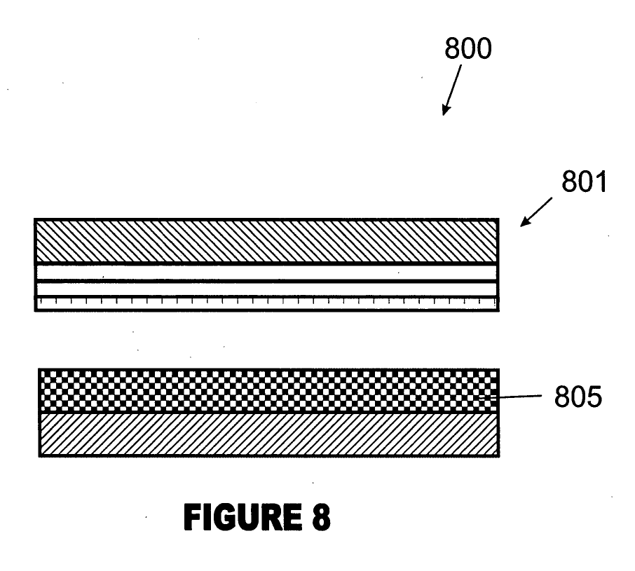

In a specific embodiment, the method also joins the planarized surface region of the resulting processed substrate 801 to a face of a handle substrate 805, as illustrated by FIG. 8. Before joining, the planarized surface region overlying the thickness of material and the handle substrate surfaces are each subjected to a cleaning solution to treat the surfaces of the substrates to clean the substrate surface regions according to a specific embodiment. An example of a solution used to clean the substrate and handle surfaces is a mixture of hydrogen peroxide and sulfuric acid, and other like solutions. A dryer dries the semiconductor substrate and the third handle surfaces to remove any residual liquids and/or particles from the substrate surfaces. Self-bonding occurs by placing surfaces of cleaned substrates (e.g., planarized region and handle substrate surface) together after an optional plasma activation process depending on the specific layer-transfer process used. If desired, such plasma activated processes clean and/or activate the surfaces of the processed substrates. The plasma activated processes are provided, for example, using an oxygen or nitrogen bearing plasma at 20° C. to 40° C. temperature. The plasma activated processes are preferably carried out in dual frequency plasma activation system manufactured by Silicon Genesis Corporation of San Jose, Calif. Of course, there can be other variations, modifications, and alternatives, which have been described herein, as well as outside of the present specification.

Thereafter, each of these substrates (and processed devices) is bonded together according to a specific embodiment. As shown, the handle substrate has been bonded to the planarized surface region. The substrates are preferably bonded using an EVG 850 bonding tool manufactured by Electronic Vision Group or other like processes for smaller substrate sizes such as 200 mm or 300 mm diameter wafers. Other types of tools such as those manufactured by Karl Suss may also be used. Of course, there can be other variations, modifications, and alternatives. Preferably, bonding between the handle substrate and the planarized surface overlying the thickness of material is substantially permanent and has good reliability.

Accordingly after bonding, the bonded substrate structures are subjected to a bake treatment according to a specific embodiment. The bake treatment maintains the bonded substrate at a predetermined temperature and predetermined time. Preferably, the temperature ranges from about 200 or 250 Degrees Celsius to about 400 Degrees Celsius and is preferably about 350 Degrees Celsius for about 1 hour or so for a planarized substrate region and the handle substrate to attach themselves to each other permanently according to the preferred embodiment. Depending upon the specific application, there can be other variations, modifications, and alternatives.

In a specific embodiment, the substrates are joined or fused together using a low temperature thermal step. In a specific embodiment, the low temperature bonding process occurs by a self-bonding process Alternatively, an adhesive disposed on either or both surfaces of the substrates, which bond one substrate to another substrate. In a specific embodiment, the adhesive includes an epoxy, polyimide-type materials, and the like. Spin-on-glass layers can be used to bond one substrate surface onto the face of another. These spin-on-glass (“SOG”) materials include, among others, siloxanes or silicates, which are often mixed with alcohol-based solvents or the like. SOG can be a desirable material because of the low temperatures (e.g., 150 to 250 Degree Celsius) often needed to cure the SOG after it is applied to surfaces of the wafers.

Alternatively, a variety of other low temperature techniques can be used to join the substrate surface region to the handle substrate. For instance, an electro-static bonding technique can be used to join the two substrates together. In particular, one or both substrate surface(s) is charged to attract to the other substrate surface. Additionally, the planarized surface can be fused to the handle wafer using a variety of other commonly known techniques. Of course, the technique used depends upon the application.

Depending upon the embodiment, the invention provides a variety of ways to process the first and second debondable surfaces to change a bond strength from a first determined amount to a second determined amount, which is capable of debonding the first debondable surface from the second debondable surface. Such surfaces can be processed through a portion or an entirety of the processing techniques and/or processed independently from any of the recited steps according to a specific embodiment.

In a specific embodiment, the processing of the first debondable surface and the second debondable surface causes a change in volume of a region within a vicinity of an interface between the first debondable surface and the second debondable surface to change the bond strength to the second determined amount. To be effective according to a specific embodiment, the volume change causes either an -in-plane stress (e.g., compressive stress) or is a patterned stress (e.g., to a “bed of nails” type of debonding where some desired patterned areas grow in volume and stresses the bond to weaken it). Of course, there can be other variations, modifications, and alternatives.

In an alternative embodiment, the processing of the first debondable surface and the second debondable surface causes a chemical reaction within a vicinity of an interface between the first debondable surface and the second debondable surface to change the bond strength to the second determined amount. As merely an example, the chemical reaction can occur by a temperature activated bond breaking reaction that scissors the bonds between the debondable surfaces or unlocks a gas such as helium or other gas or gases, for example, that accumulates causes stresses, which weakens the surface(s) according to a specific embodiment. In an alternative embodiment, the processing of the first debondable surface roughness within a vicinity of an interface between the first debondable surface and the second debondable surface to change the bond strength to the second determined amount. Alternatively, the bond regime changes a little but the cleave strength is selected to allow cleaving in an adherence regime according to a specific embodiment. Depending upon the embodiment, one or more of these processes may be used. Of course, there can be other variations, modifications, and alternatives.

In a specific embodiment, the method includes debonding the first debondable surface from the second debondable surface to release the thickness of material and the handle substrate to form a resulting substrate 900 In a preferred embodiment, the debonding occurs within an interface regime between the first and second debondable surfaces. Such surfaces became debondable by one or more processes that changed the bonded characteristic at the interface to an adhesion characteristic, which is capable of being debonded, according to a specific embodiment. In a specific embodiment, the method may use a cleaving action to separate the two debondable surfaces from each other according to a specific embodiment. As merely an example, such cleaving action may be provided by a cleaving tool, such as those noted in PCT/US05/00747 filed Jan. 10, 2005 (Attorney Docket No. 18419-017100PC), commonly assigned and hereby incorporated by reference for all purposes. Additionally, debonding occurs without any breakage of integrated circuit device elements and/or substrate materials according to a specific embodiment. Of course, there can be other variations, modifications and alternatives.

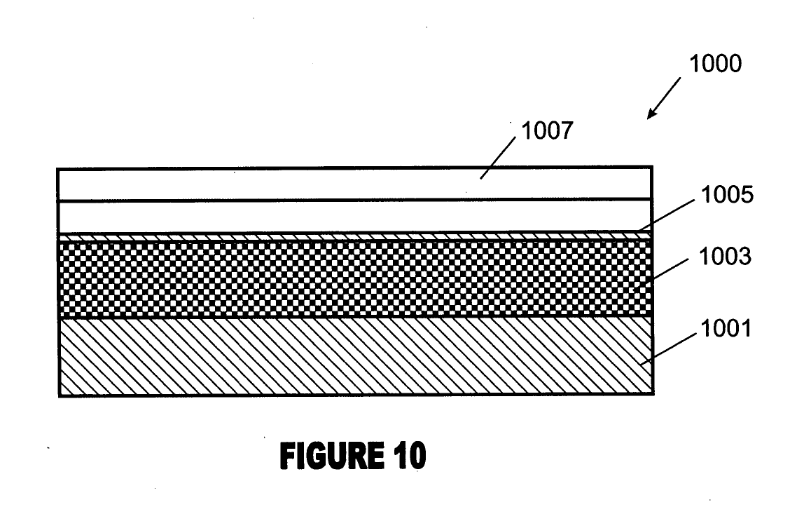

Additionally processes may include repeating the layer transfer processes to form resulting multi-layered substrate structure 1000 according to a specific embodiment, as illustrated by FIG. 10. The structure 1000 includes bulk substrate 1001. The bulk substrate includes an overlying layer 1003, which may be a layer transferred layer (e.g., silicon, strained silicon, germanium, <111> or <100> or <110> single crystal silicon) or other layer. The overlying layer 1003 includes layer transferred layer 1005, which has processed and completed device structures thereon. Overlying layer 1005 includes one or more layers 1007, which also may be layer transferred, deposited, or any combination of these, according to a specific embodiment Of course, there can be other variations, modifications, and alternatives.

While the above is a full description of the specific embodiments, various modifications, alternative constructions and equivalents may be used. That is, the present invention has been described in terms of specific types of substrates. Such substrates may be single homogeneous materials, multilayer, and/or any combination of these, and the like. Additionally, such substrates may be a portion of a susceptor device, such as an electrostatic chuck according to an embodiment. The electrostatic chuck or other like chuck (e.g., mechanical) can be used as a transfer substrate according to a specific embodiment. Additionally, if the substrate becomes too thin or incompatible with a cleaving process, the substrate may be subjected to a backing substrate, which will provide for a suitable stiffness to allow for cleaving according to an embodiment of the present invention. The backing substrate can be a silicon substrate, a glass substrate, a metal substrate, or any other combination of these, and certain susceptor designs (e.g., vacuum or electrostatic chuck) to provide a suitable rigidity for cleaving to occur. Of course, there can be other variations, modifications, and alternatives. Other techniques for forming multi-layered substrates, which may be combined with any of the elements herein, can be found in U.S. Ser. No. ______ (Attorney Docket No. 18419-018400US) filed on the same date as the present application, commonly assigned, and hereby incorporated by reference for all purposes. Therefore, the above description and illustrations should not be taken as limiting the scope of the present invention which is defined by the appended claims.

What is claimed is:

1. A method for fabricating one or more devices, the method comprising:
providing a multi-layered substrate, the multi-layered substrate having a thickness of material overlying a first debondable surface coupled to and overlying a second debondable surface, the first and second debondable surfaces defining an interface region of the multi-layered substrate, the thickness of material having a surface region;
processing the surface region of the multi-layered substrate using one or more processes to form at least one device onto a portion of the surface region overlying the surface region of the thickness of material;
joining the planarized upper surface region to a face of a handle substrate;
processing the first debondable surface and the second debondable surface to change a bond strength from a first determined amount to a second determined amount, the second determined amount being capable of debonding the first debondable surface from the second debondable surface; and
debonding the first debondable surface from the second debondable surface to release the thickness of material and the handle substrate.

2. The method of claim 1 wherein the processing of the first debondable surface and the second debondable surface causes a change in volume of a region within a vicinity of the said interface region to change the bond strength to the second determined amount

3. The method of claim 1 wherein the processing of the first debondable surface and the second debondable surface causes a chemical reaction within a vicinity of the said interface region to change the bond strength to the second determined amount.

4. The method of claim 1 wherein the processing of the first debondable surface and the second debondable surface comprises a thermal process to causes an increased surface roughness within a vicinity of the said interface region to change the bond strength to the second determined amount.

5. The method of claim 1 wherein the first determined amount allows for processing the surface region of the multi-layered substrate to a temperature greater than about 1000 degrees Centigrade without any de-lamination of the first debondable surface from the second debondable surface.

6. The method of claim 1 wherein the processing of the first debondable surface and the second debondable surface comprises a thermal process to causes an increased surface roughness to about 10 Angstroms RMS and greater within the said interface region and the second debondable surface to change the bond strength to the second determined amount.

7. The method of claim 1 wherein the multi-layered substrate comprises a silicon wafer.

8. The method of claim 1 wherein the multi-layered substrate comprises a silicon bearing material.

9. The method of claim 1 wherein the thickness of semiconductor material is single crystal silicon material.

10. The method of claim 1 wherein the multi-layered substrate comprises at least one layer.

11. The method of claim 1 wherein the thickness of material is provided by a cleaving process.

12. The method of claim 1 wherein the first debondable surface comprises a first oxide layer.

13. The method of claim 1 wherein the second debondable surface comprises a second oxide layer.

14. The method of claim 1 wherein the thickness of material overlying the first debondable surface is provided using a controlled cleaving process.

15. The method of claim 1 the second determined bond strength is less than a bond strength associated with the planarized upper surface region and the face of the handle substrate, the second determined bond strength being characterized as being cleavable after the face of the handle substrate has been attached to the planarized upper surface region.

16. The method of claim 1 wherein the first determined bond strength and the second determined bond strength are within an adherence regime range.

17. The method of claim 1 wherein the second determined bond strength is less than a bond strength associated with the planarized upper surface region and the face of the handle substrate.

18. The method of claim 1 wherein the first determined bond strength is equal to the second determined bond strength.

19. The method of claim 1 wherein the first determined bond strength is greater than the second determined bond strength.

20. A method for fabricating one or more devices, the method comprising:
providing a multi-layered substrate, the multi-layered substrate having a thickness of material overlying a first debondable surface coupled to and overlying a second debondable surface, the first and second debondable surfaces defining an interface region of the multi-layered substrate, the thickness of material having a surface region;
processing the surface region of the multi-layered substrate using one or more processes to form at least one device onto a portion of the surface region;
forming a planarized upper surface region overlying the surface region of the thickness of material;
joining the planarized upper surface region to a face of a handle substrate;
processing the first debondable surface and the second debondable surface using a thermal process to change a bond strength from a first determined amount to a second determined amount, the second determined amount being capable of debonding the first debondable surface from the second debondable surface, the thermal process causing a change in one or more characteristics within a vicinity of the said interface region to change the bond strength from the first determined amount to the second determined amount; and debonding the first debondable surface from the second debondable surface to release the thickness of material and the handle substrate.

21. The method of claim 20 wherein the first determined amount allows for processing the surface region of the multi-layered substrate to a temperature greater than about 1000 degrees Centigrade without any de-lamination of the first debondable surface from the second debondable surface.

22. The method of claim 20 wherein the one or more characteristics is an increased surface roughness of about 10 Angstroms RMS and greater within the vicinity of the said interface region to change the bond strength to the second determined amount.

23. The method of claim 20 wherein the multi-layered substrate comprises a silicon wafer.

24. The method of claim 20 wherein the multi-layered substrate comprises a silicon bearing material.

25. The method of claim 20 wherein the thickness of semiconductor material is single crystal silicon material.

26. The method of claim 20 wherein the thickness of semiconductor material is germanium, silicon carbide, or gallium arsende.

27. The method of claim 20 wherein the multi-layered substrate comprises at least one layer.

28. The method of claim 20 wherein the thickness of material is provided by a cleaving process.

29. The method of claim 20 wherein the first debondable surface comprises a first oxide layer.

30. The method of claim 20 wherein the second debondable surface comprises a second oxide layer.

31. The method of claim 20 wherein the thickness of material overlying the first debondable surface is provided using a controlled cleaving process.

32. The method of claim 20 wherein the first determined amount is within a bonding regime and the second determined amount is within an adherence regime.

33. The method of claim 20 wherein the thermal process is provided during a portion of the processing of the surface region.

34. The method of claim 20 wherein the thermal process is provided during a portion of the processing of the surface region and one or more other processes during a manufacture of an integrated circuit device.

35. The method of claim 20 wherein the first determined amount is within a bonding regime and the second determined amount is within an adherence regime, the adherence regime providing for an ability to remove the first debondable surface from the second debondable surface.

36. The method of claim 20 wherein the second determined bond strength is less than a bond strength associated with the planarized upper surface region and the face of the handle substrate.

37. The method of claim 20 wherein the first determined bond strength is within an adherence regime.

38. The method of claim 20 wherein the second determined bond strength is less than a bond strength associated with the planarized upper surface region and the face of the handle substrate and the second determined bond strength being characterized as cleavable after the planarized upper surface region and the face of the handle substrate have been joined.

39. The method of claim 20 wherein the first determined bond strength is the same as the second determined bond strength.

40. The method of claim 20 wherein the first determined bond strength is greater than the second determined bond strength.

41. A method for fabricating one or more devices, the method comprising:
providing a donor substrate having a thickness of material overlying a cleave region, the donor substrate having a first debondable surface overlying the thickness of material;
joining the first debondable surface with a second debondable surface of a first handle substrate;
cleaving the cleave region to transfer the thickness of material from the donor substrate to the handle substrate while the first debondable surface remains attached to the second debondable surface to form a multi-layered substrate, the multi-layered substrate having the thickness of material overlying the first debondable surface coupled to and overlying the second debondable surface, the first debondable surface and the second debondable surface defining an interface region of the multi-layered substrate, the thickness of material having a surface region;
processing the surface region of the multi-layered substrate using one or more processes to form at least one device onto a portion of the surface region;
forming a planarized upper surface region overlying the surface region of the thickness of material;
joining the planarized upper surface region to a face of a handle substrate;
processing the first debondable surface and the second debondable surface to change a bond strength from a first determined amount to a second determined amount, the second determined amount being capable of debonding the first debondable surface from the second debondable surface; and
debonding the first debondable surface from the second debondable surface to release the thickness of material and the handle substrate.

42. The method of claim 41 wherein the first debondable surface joined to the second debondable surface is characterized by a bond strength greater than a strength of the cleave region after the first debondable surface has been joined to the second debondable surface.

43. The method of claim 42 wherein the second determined bond strength is less than a bond strength associated with the planarized upper surface region and the face of the handle substrate and the second determined bond strength being characterized as cleavable after the planarized upper surface region and the face of the handle substrate have been joined.
